(19) United States
(12) Patent Application Publication
(10) Pub. No.: US 2016/0271849 A1
(43) Pub. Date: Sep. 22, 2016

(54) A MOULD

(71) Applicants: BOE TECHNOLOGY GROUP CO., LTD., Beijing (CN); BEIJING BOE VISION-ELECTRONIC TECHNOLOGY CO., LTD., Beijing (CN)

(72) Inventor: Wei HUANG, Beijing (CN)

(21) Appl. No.: 14/778,110

(22) PCT Filed: Apr. 20, 2015
(86) PCT No.: PCT/CN2015/076952

§ 371 Date: Sep. 18, 2015

(30) Foreign Application Priority Data
Sep. 23, 2014 (CN) 201420548774.3

(51) Int. Cl. B29C 45/26

(52) U.S. Cl. CPC B29C 45/2602; B29L 2031/757

(57) ABSTRACT

Disclosed is a mould including a female mould having a cavity insert and a male mould having a core insert. The mould further includes a guiding block and a sliding block accommodated in a receiving chamber of core insert; the sliding block is movable along a surface of female mould; a first end of sliding block is connectable to male mould through a resilient member; a first recess is formed on a side of sliding block facing cavity insert; the guiding block is provided in cavity insert and protruded towards male mould; a portion of guiding block can be inserted into recess to compress the resilient member; the sliding block is formed thereon with a moulding surface; and the moulding surface together with moulding surfaces of core insert and cavity insert form a moulding cavity. In addition, a catch groove is provided on the moulding surface of sliding block.

### CROSS-REFERENCE TO RELATED APPLICATION

This application claims the priority of Chinese Patent Application No. 201420548774.3 filed on Sep. 23, 2014 in the Chinese Intellectual Property Office, the disclosure of which is incorporated herein by reference.

### FIELD OF THE INVENTION

The present invention relates to the field of mould, and in particular, to the design and manufacturing of a mould.

### BACKGROUND OF THE INVENTION

Generally, a product having a catch may be moulded by means of a taper pin. For example, as shown in FIGS. 1 and 2, a cavity insert 1 and a core insert 2 cooperate with each other. The core insert 2 is provided with a taper pin 3 on which a catch groove 31 is formed. Therefore, a catch 41 corresponding to the catch groove 31 can be formed in an injection-moulded product 4. In the existing mould, as shown in FIGS. 1 and 2, the taper pin 3 can be moved downwards as indicated by an arrow in FIG. 2. In the case that the product 4 has a relatively simple design (for example, a portion 42 exceeding the taper pin 3 will not interfere with movement of the taper pin 3), it is very easy to release the catch 41 of the product 4 from the catch groove 31 of the taper pin 3, thereby realizing the manufacturing of the moulded product 4 having the catch 41.

However, as shown in FIG. 3, when the product 4 have a complicated configuration such as a curved surface, the portion 42 exceeding the taper pin 3 will interfere with the movement of the taper pin 3, causing that the catch 41 of the product 4 is hardly to be released from the catch groove 31 of the taper pin 3. Thus, it is difficult to form the moulded product 4 having the catch 41 by means of the taper pin 3. Therefore, when moulding a product having a complicated configuration, design of the catch will become a problem.

### SUMMARY OF THE INVENTION

An objective of this disclosure is to provide a mould for moulding a product having a complicated configuration and having a catch.

In order to solve the technical problems as set forth above, the mould provided by the disclosure includes a female mould and a male mould, the female mould including a cavity insert and the male mould including a core insert. The mould further includes a guiding block and a sliding block, and the core insert is formed therein with a receiving chamber for retaining the sliding block; the sliding block is able to be moved along a parting surface of the female mould; a first end of the sliding block is able to be connected to the male mould through a resilient member; a first recess is formed on a side of the sliding block facing the cavity insert; the guiding block is provided in the cavity insert and protruded towards the male mould; a portion of the guiding block exceeding the cavity insert is able to be inserted into the first recess, such that the resilient member is compressed; the sliding block is formed thereon with a moulding surface; and, the moulding surface of the sliding block together with a moulding surface of the core insert and a moulding surface of the cavity insert collectively form a moulding cavity.

Optionally, a second end of the sliding block has a protrusion facing the cavity insert; the moulding surface of the sliding block is formed on a lower surface of the protrusion, and a catch groove is provided on the moulding surface of the sliding block; when the male mould and the female mould are assembled, a clearance is formed between an upper surface of the second end of the sliding block and the core insert; and, a maximum height of the clearance in the moving direction of the sliding block is greater than a depth of the catch groove.

Optionally, the male mould further includes a male mould plate; the resilient member is fixedly connected to the male mould plate at one end and fixedly connected to the sliding block at the other end.

Optionally, the male mould plate is provided with a second recess in which the resilient member is retained.

Optionally, a portion of the guiding block is fixed to the cavity insert in an inserted manner.

Optionally, the portion of the guiding block exceeding the cavity insert has an upwards inclined lower surface; when the male mould and the female mould are assembled, a lower surface of the first recess is brought into contact with a lower surface of the portion of the guiding block exceeding the cavity insert.

In the mould provided by the disclosure, the sliding block and the guiding block can cooperate with each other, such that the mould is able to mould a product having a curved configuration and having a catch, whereby solving a problem that it is difficult for the existing mould to mould a product having a complicated configuration.

### BRIEF DESCRIPTION OF THE DRAWINGS

Accompanying drawings are provided for further understanding of this disclosure and constituting a part of the specification. Hereinafter, these drawings are intended to explain the disclosure together with the following specific embodiments, but should not be considered as a limitation of the disclosure.

FIG. 1 is a schematic cross-sectional view showing a mould in the prior art;

FIG. 2 is a schematic cross-sectional view showing a mould in the prior art;

FIG. 3 is a schematic cross-sectional view showing a mould in the prior art;

FIG. 4 is a schematic cross-sectional view showing a mould according to this disclosure in an assembled state;

FIG. 5 is an enlarged schematic cross-sectional view showing the mould according to this disclosure in the mould assembled state; and

FIG. 6 is an enlarged schematic cross-sectional view showing the mould according to this disclosure in a parted state.

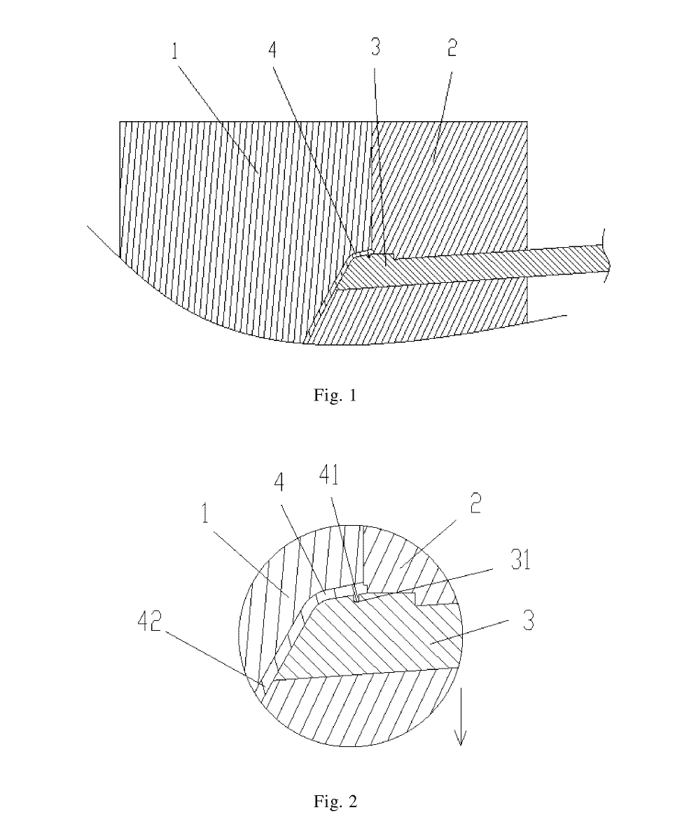

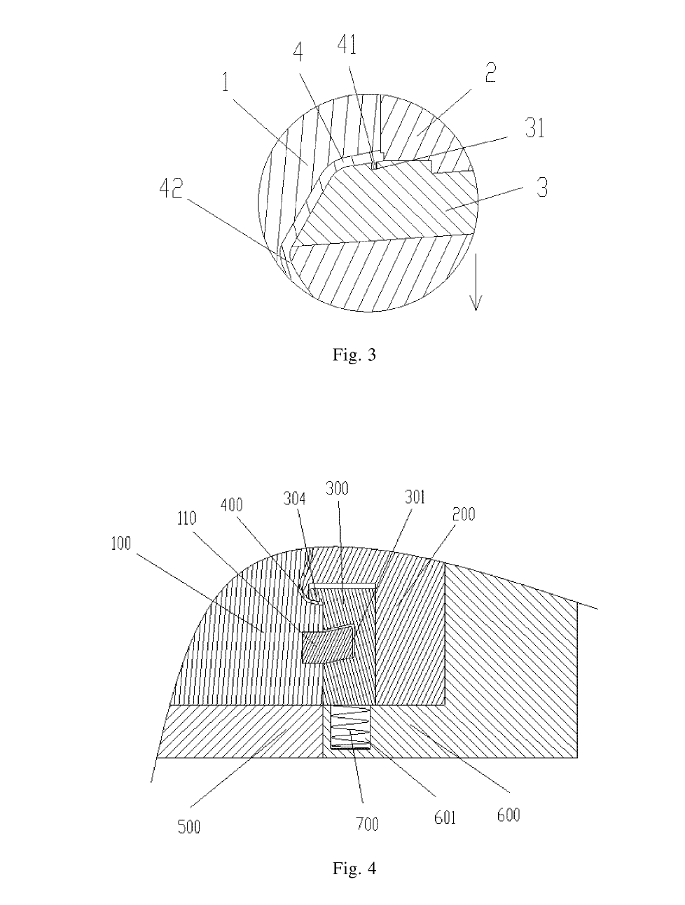

In reference numerals, 1, 100-a cavity insert; 2, 200-a core insert; 3-a taper pin; 31, 303-a catch groove; 4, 400-a product; 41, 401-a catch; 42-a portion exceeding the taper pin; 110-a guiding block; 111-a lower surface of a portion of the guiding block exceeding the cavity insert; 300-a sliding block; 301-a first recess; 3011-a lower surface of the first recess; 304-a protrusion; 500-a female mould plate; 600-a male mould plate; 601-a second recess; 700-a resilient member; 800-a clearance.

### DETAILED DESCRIPTION OF THE EMBODIMENTS

Hereinafter, specific embodiments of the disclosure will be described in detail in conjunction with the accompanying drawings. It should be understood that the specific embodiments as set forth herein are merely for the purpose of illustration and explanation of the disclosure and should not be constructed as a limitation thereof.

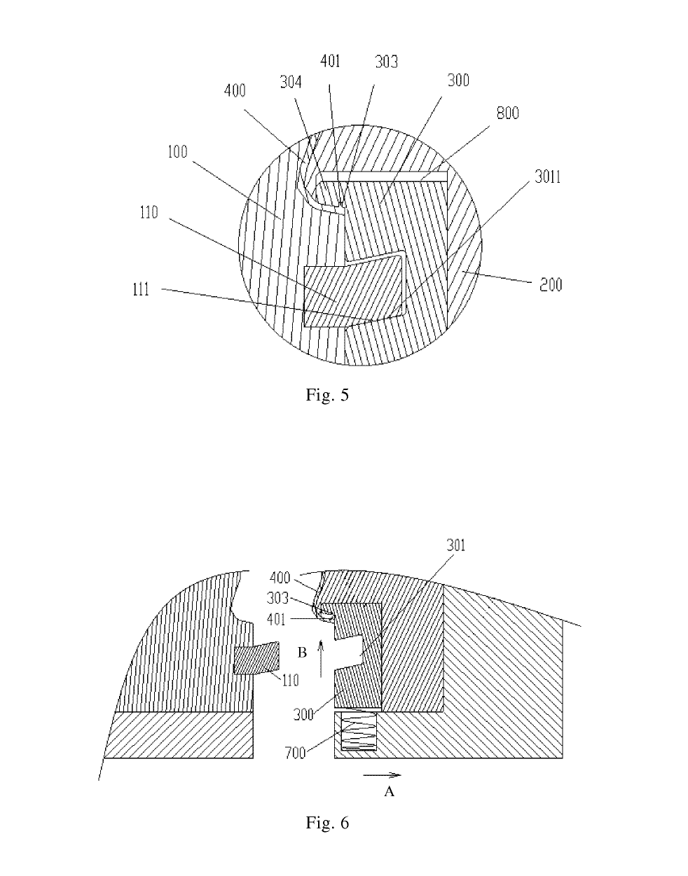

A mould according to the disclosure may include a female mould and a male mould. FIGS. 4 and 5 are schematic views showing the mould according to the disclosure in which the female mould and the male mould are in an assembled state, while FIG. 6 is a schematic view showing the mould according to the disclosure in which the female mould and the male mould are in a parted state.

The female mould includes a cavity insert 100, and the male mould includes a core insert 200. The mould may further include a guiding block 110 and a sliding block 300. The core insert 200 is formed therein with a receiving chamber for retaining the sliding block 300. The sliding block 300 can be moved along a parting surface of the female mould. A first end of the sliding block 300 can be connected to the male mould through a resilient member 700. In this embodiment, the resilient member 700 may be a spring.

As shown in FIG. 4, a first recess 301 is formed on a side of the sliding block 300 facing the cavity insert 100. The guiding block 110 is provided in the cavity insert 100 and protruded towards the male mould. A portion of the guiding block 110 exceeding the cavity insert 100 is able to be inserted into the first recess 301, such that the resilient member 700 is compressed. When the guiding block 110 is inserted into the first recess 301, the female mould and the male mould are in the assembled state.

The sliding block 300 is formed thereon with a moulding surface. As shown in FIGS. 4 and 5, the moulding surface of the sliding block together with a moulding surface of the core insert 200 and a moulding surface of the cavity insert 100 collectively form a moulding cavity. In FIGS. 4 and 5, a product 400 is contained in the moulding cavity. As could be seen from figures, in accordance with a shape of the moulding surface of the sliding block, moulded products having various configurations can be formed by injection moulding.

Referring to FIGS. 4 and 6, it can be seen that the sliding block 300 may be positioned at two positions, wherein the sliding block 300 is positioned at the first position before mould assembling, and the sliding block 300 is positioned at the second position after mould assembling. In this embodiment, a top surface of the sliding block 300 before mould assembling is higher than that after mould assembling. Specifically, in the process of mould assembling, the sliding block 300 is moved downwards along the parting surface, such that the resilient member 700 is compressed; while in the process of mould parting, the sliding block 300 is moved upwards along the parting surface under the action of a restoring force of the resilient member to arise the sliding block 300. According to this disclosure, in the process of mould parting, the sliding block 300 can be separated from the injection-moulded product 400 without an ejection mechanism such as an ejection rod.

Further, a protrusion 304 facing the cavity insert 100 is formed at a second end (an end which is not in connection with the resilient member 700) of the sliding block 300. The moulding surface of the sliding block is formed on a lower surface of the protrusion 304, and as shown in FIG. 5, a catch groove 303 is provided on the moulding surface of the sliding block. When the male mould and the female mould are assembled, a clearance 800 is formed between an upper surface of the second end (the end which is not in connection with the resilient member 700) of the sliding block 300 and the core insert 200. In this embodiment, a maximum height of the clearance 800 in the moving direction of the sliding block 300 is greater than a depth of the catch groove 303. When the male mould and the female mould are assembled to be injected, a catch 401 of the product 400 can be formed in the catch groove 303. When the male mould and the female mould are parted, a movable distance of the sliding block 300 is limited by the height of the clearance 800. If the maximum height of the clearance 800 in the moving direction of the sliding block 300 is greater than the depth of the catch groove 303, it may facilitate the release of the catch 401 of the product 400 from the catch groove 303.

Compared with the prior art, in the mould provided according to this disclosure, the sliding block 300 can be used cooperatively with the guiding block 110, such that the mould of the disclosure is able to mould a product (such as, the product 400) having a complicated configuration such as a curved surface and having a catch, whereby solving a problem that it is difficult for the existing mould to design a catch for a product having a complicated configuration.

Optionally, the female mould may further include a female mould plate 500, and the male mould may further include a male mould plate 600.

In this disclosure, the position of the resilient member 700 is not specifically restricted, as long as the resilient member 700 can apply a resilient force to the sliding block 300. For example, the receiving chamber of the core insert 200 may be a recess with three closed sides (at least the bottom side thereof is closed) and one open side in its cross section, and the resilient member 700 is provided on the bottom side of the receiving chamber; or, the receiving chamber has two open sides in its cross section (as shown in FIGS. 4 and 6), and in this case, the resilient member 700 may be provided on the male mould plate 600. As shown in FIGS. 4 and 6, the resilient member 700 is fixedly connected to the male mould plate 600 at one end and fixedly connected to the sliding block 300 at the other end. As an alternative, the male mould plate 600 may be provided with a second recess 601 in which the resilient member 700 is retained, as shown in FIG. 4. The second recess 601 may easily seat the resilient member 700 in place.

In this disclosure, the guiding block 110 is fixed to the cavity insert 100. For example, a portion of the guiding block 110 may be fixed to the cavity insert 100 in an inserted manner. Alternatively, the guiding block 110 may be formed integrally with the cavity insert 100. However, the guiding block 110 is preferably inserted into the cavity insert 100, so that the cavity insert 100 and the guiding block 110 may be processed individually to decrease complexity in process. As shown in FIGS. 4-6, a portion of the guiding block 110 exceeding the cavity insert 100 may optionally have an upwards inclined lower surface. When the male mould and the female mould are assembled, a lower surface 3011 of the first recess 301 is brought into contact with a lower surface 111 of the portion of the guiding block 110 exceeding the cavity insert 100, as shown in FIG. 5.

Operational modes of the mould provided by the disclosure will be described hereinafter.

FIGS. 4 and 5 are schematic cross sectional views of the mould provided by the disclosure after mould assembling. The processes of assembling the mould are as follows: the guiding block 110 is inserted into the first recess 301 to cooperate with the sliding block 300; with the inserting of the guiding block 110 into the first recess 301, the upwards inclined lower surface 111 of the guiding block 110 compulsively depresses the sliding block 300 until the female mould and the male mould are assembled; in the process of the mould assembling, the resilient member 700 is being compressed. Then the moulding cavity is filled with injection materials to mould the product 400 with the catch 401.

FIG. 6 shows a process of the mould parting. In this process, as the male mould is moved in a direction as indicated by an arrow A, the guiding block 110 is released from the first recess 301. At this point, the sliding block 300 is moved upwards under the action of the resilient member 700 (in this embodiment, a spring) until the second end of the sliding block 300 is brought into contact with the core insert 200, as indicated by an arrow B. In this process, the moving distance of the sliding block 300 under the action of the resilient member 700 is equal to the height of the clearance 800. Since the height of the clearance 800 is greater than the depth of the catch groove 303, the catch 401 of the product 400 can be completely released from the catch groove 303.

In the prior art, it is difficult to mould a complicated product having a curved surface and having a catch by means of the taper pin. According to this disclosure, however, the catch of the product can be easily released from the catch groove 303 by the cooperation of the sliding block 300 with the guiding block 110.

In addition, the lower surface of the protrusion 304 of the sliding block 300 is used as the moulding surface of the sliding block, on which the catch groove 303 is provided. Therefore, the curved configuration of the product having the catch can be changed simply by adjusting the shape of the moulding surface of the sliding block, so that the problem that it is difficult for the existing mould to mould a product having a complicated configuration is solved.

It should be understood that the above implementations are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

1. A mould, which includes a female mould and a male mould, the female mould including a cavity insert and the male mould including a core insert, wherein
the mould further includes a guiding block and a sliding block, and the core insert is formed therein with a receiving chamber for retaining the sliding block; the sliding block is able to be moved along a parting surface of the female mould; a first end of the sliding block is able to be connected to the male mould through a resilient member; a first recess is formed on a side of the sliding block facing the cavity insert;
the guiding block is provided in the cavity insert and protruded towards the male mould; a portion of the guiding block exceeding the cavity insert is able to be inserted into the first recess, such that the resilient member is compressed; the sliding block is formed thereon with a moulding surface; and, the moulding surface of the sliding block together with a moulding surface of the core insert and a moulding surface of the cavity insert collectively form a moulding cavity.

2. The mould according to claim 1, wherein
a second end of the sliding block has a protrusion facing the cavity insert; the moulding surface of the sliding block is formed on a lower surface of the protrusion, and a catch groove is provided on the moulding surface of the sliding block; when the male mould and the female mould are assembled, a clearance is formed between an upper surface of the second end of the sliding block and the core insert; and, a maximum height of the clearance in the moving direction of the sliding block is greater than a depth of the catch groove.

3. The mould according to claim 1, wherein
the male mould further includes a male mould plate; the resilient member is fixedly connected to the male mould plate at one end and fixedly connected to the sliding block at the other end.

4. The mould according to claim 3, wherein
the male mould plate is provided with a second recess in which the resilient member is retained.

5. The mould according to claim 1, wherein
a portion of the guiding block is fixed to the cavity insert in an inserted manner.

6. The mould according to claim 1, wherein
the portion of the guiding block exceeding the cavity insert has an upwards inclined lower surface; when the male mould and the female mould are assembled, a lower surface of the first recess is brought into contact with a lower surface of the portion of the guiding block exceeding the cavity insert.
